(19) United States
(12) Patent Application Publication
(10) Pub. No.: US 2012/0071147 A1
(43) Pub. Date: Mar. 22, 2012

(54) METHOD FOR CALL CONTROL WHEN SETTING UP A COMMUNICATION LINK

(76) Inventors: Florian Prikowitsch, Orth/Donau (AT); Sascha Valentin, Wien (AT)

(21) Appl. No.: 13/254,613

(22) PCT Filed: Jun. 4, 2010
(86) PCT No.: PCT/EP10/03378

§ 371 Date: Sep. 30, 2011

(30) Foreign Application Priority Data
Jun. 4, 2009 (DE) 10 2009 023 927.8

(51) Int. Cl. H04W 40/00; H04M 3/42; H04W 24/00

(52) U.S. Cl. 455/417; 455/445

(57) ABSTRACT

The inventions relates to a method for call control when setting up a communication link from a first calling terminal device, particularly from a mobile radio terminal device which logged into or associated with a first communication network, via one or more communication networks to at least one called terminal device, wherein a server associated with the first communication network is used to report back the current status to the calling terminal device from the network. According to the invention an application is used to evaluate the status reported back from the network and a plurality of different actions can be defined and performed within the call control upon the status reported back from the network. Depending on said status one or more action(s) is/are performed which emanate(s) from the first calling terminal device and/or which is/are allocated thereto.

The invention relates to a method for call control when setting up a communication link from a first calling terminal device, particularly from a mobile radio terminal device which is logged into or is associated with a first communication network, via one or more communication networks to at least one called terminal device, wherein a server associated with the first communication network is used to report back the current status to the calling terminal device from the network.

Such methods for call control when setting up a communication link are known. In particular, it is known practice to signal to the calling terminal device that the called subscriber is unavailable or that the line is busy, for example. It is also known practice for the called subscriber, known as the B subscriber, to be able to implement various actions, such as call diversion or an individual mailbox announcement.

A drawback of the known methods is that the caller, i.e. the A subscriber, is not able to individually prescribe any kind of actions, but rather he is merely able to react to the status reported back from the network.

The object of the invention is therefore to develop a method for call control when setting up a communication link from a first calling terminal device such that the caller, i.e. the A subscriber, is able to individualize outgoing actions and define actions resulting therefrom in order to be able to react to any reported call statuses as desired and to be able to act.

The invention achieves this object by means of a method according to claim 1. Advantageous developments of the invention are specified in the subclaims.

A particular advantage of the method for call control when setting up a communication link from a first calling terminal device, particularly from a mobile terminal device which is logged into or associated with a first communication network, via one or more communication networks to at least one called terminal device, wherein a server associated with the first communication network is used to report back the current status to the first terminal device from the network, is that an application is used to evaluate the status reported back from the network and can be used to define and perform a plurality of different actions within the call control upon the status reported back from the network, wherein depending on said status one or more action(s) is/are performed which emanate(s) from the first calling terminal device and/or which is/are allocated thereto.

Preferably, the first calling terminal device is therefore a mobile radio terminal device within a mobile radio network. The invention is not limited thereto, however, and can also be applied to fixed line terminal devices which are associated with a fixed line network.

However, in this context, the term communication network also covers any form of such networks, particularly data networks, fixed telephone networks and also mobile radio networks.

By means of the invention a method can be performed, including interfaces therefore, enabling the A subscriber, i.e. the caller himself, to individualize outgoing actions, such as calls, short messages (SMS), multimedia messages (MMS) and the like and to define the actions resulting from the call status. This is preferably realized by a software, installed on the local terminal device of the caller, i.e. of the A subscriber, for controlling actions and the server which is connected to the related network for the purpose of forwarding the respective network or call status, or for independently implementing the actions defined by the A subscriber.

The status to be evaluated is thus reported by a server in the first communication network. In this case, first communication network denotes any network which the calling terminal device is logged into or with which it is associated. To set up a communication link to the B subscriber, one or more networks, particularly also mobile radio networks, may also be incorporated.

Preferably, the status reported back to the calling first terminal device from the network is the call status and/or the login status of the called terminal device, and/or the availability of the called terminal device and/or the network status, particularly the availability of the network or resource availability within the communication network(s).

By way of example, the call status may be the message that the call is outgoing. It is also possible to report back whether or not the terminal device of the called B subscriber is currently logged into the network. If mobile radio networks are used, status may also denote the quality or availability of a radio link. The term network status particularly covers the resource availability within the network, particularly a mobile radio network, and/or the network utilization and/or the case of network overload.

The term current status therefore covers individual or a plurality of relevant status messages, so that the invention allows comprehensive and meaningful call control.

The actions of the A subscriber or of the calling terminal device associated with the A subscriber which are able to be defined for call control may be the transmission of an identifier for the calling terminal device, such as a telephone number and/or a name transmission and/or may be a prescribable individual announcement or recording and/or a generated announcement and/or a text message (SMS) and/or a multimedia message (MMS) which is transmitted to the called terminal device or a memory unit associated with said terminal device.

By way of example, the term memory unit thus covers a recording unit, a telephone answering machine or an electronic memory or the like. It may also be a buffer integrated in a communication network in order to allow transmission at a later time if the called terminal device of the B subscriber is is currently not logged in or available.

In one preferred embodiment, the action which can be defined for call control is call diversion and/or call forwarding.

This allows the A subscriber, i.e. the caller, to define call forwarding operations already, e.g. if the called terminal device of the B subscriber is currently not logged in to the network or the line is busy.

In one preferred embodiment, the action to be performed on the basis of the status report within the call control is configured using a user interface associated with the first terminal device.

Preferably, the terminal device, particularly in the form of a mobile radio terminal device, has a graphical user interface with appropriate menu control in order to allow simple configuration and use for the user and particularly in order to associate the possible actions to be implemented with the status reports and to perform the configuration.

Preferably, an application is provided which is used to configure the actions to be performed on the basis of the status report within the call control.

In this case, the application can be executed on the first calling terminal device of the A subscriber and/or on a server associated with the first communication network. However, it is also possible for this application to be executed in a distributed manner both on the first calling terminal device of the A subscriber and on a server associated with the first communication network. This allows the greatest possible breadth of application. In particular, the method can also be applied if the terminal device used is unsuitable for installing and is executing an appropriate application for executing the method. In this case, the call control can be shifted completely to the server.

If the application by means of which the method is executed and/or controlled is executed on the first calling terminal device of the A subscriber, the application can be provided by a server associated with the first communication network and can be transmitted to the terminal device.

In order to prevent misuse, it is possible for the user of the first terminal device, i.e. the A subscriber, to log on to and/or register on a server associated with the first communication network, particularly by means of the transmission of a telephone number associated with the first terminal device, particularly an ISDN or an MSISDN, and/or an appliance number, where a status report is transmitted by the network server only to logged-on and/or registered terminal devices.

An exemplary embodiment of the invention may have the following appearance: An A subscriber installs an appropriate piece of application software on his terminal device. The settings implemented on the terminal device provide the A subscriber with the option of implementing and prescribing certain actions on the basis of the status reports and events reported back in the course of the call control.

By way of example, these actions prescribed by the A subscriber may be individual announcements, tones or music, or may be the implementation of diversions and call forwarding operations. In addition, it is possible to send ready-made text messages and/or multimedia messages and/or voice messages, particularly including individual recorded voice messages and the like. It is also possible to generate and transmit appropriate announcements, and, by way of example, also to make calendar entries for a requested return call if the B subscriber is unavailable. The application associated with the A subscriber terminal device therefore contains the logic for how to react to respective events. In addition, obtainment or use of the application itself does not necessarily require logon. Provision may be made for this for reasons of security, however.

The network services required for the application to work are signaled to the terminal device of the respective A subscriber in real time using a server which needs to be provided for this purpose, and are based on the call statuses or network statuses which are typical of the respective network.

Preferably, use of the functionality implemented on the server, such as the signaling and transmission of network statuses etc., requires logon by the A subscriber or registration using his terminal device in order to prevent possible misuse, or in order to be able to explicitly associate the services used with the subscriber.

In this case, the network operator can use the server itself to define a list of network statuses which are requested from the network or are signaled and transmitted to the terminal device of the A subscriber.

The server preferably has an appropriate database associated with it which stores particularly subscriber data records and/or configurations in retrievable form.

If, although an A subscriber is registered, he does not have an appropriate application installed on his terminal device, for example if the terminal device he uses does not provide this option, it is also possible for actions to be controlled directly by means of an appropriate profile on the server of the network itself, said profile being explicitly allocated to the A subscriber by an appropriate database on the server. Access to such a profile is then possible using an Internet interface for the user, i.e. the A subscriber, for example.

Regardless of the manufacturer of the terminal device used by the A subscriber or of the operating system running on said terminal device, the basic function of the application comprises processing of the events, i.e. of the reported status information, signaled by the subscription/application server of the communication network in real time.

The settings implemented on the terminal device and/or on the server provide the A subscriber (caller) with the option of implementing/controlling the desired actions on the basis of events reported back in the course of the call control (call handling).

Said A subscriber actions may be the following, for example:
individual announcements, tones or music, particularly for calls via a mobile radio network,
the implementation of diversions and/or forwarding operations,
the sending of ready-made SMS/MMS/voice messages,
the generation of appropriate announcements,
the making of calendar entries relating to return calls.

The A subscriber application (on the terminal device of the A subscriber) is therefore the actual A subscriber interface and contains the logic for how to react to respective events. For the purpose of communication with the subscription/application is server of the network, an appropriate interface is provided (e.g. using binary SMS).

For the execution of individual A subscriber actions, resources required for this purpose are, in principle, stored/available on the terminal device itself.

The following options are conceivable in order to install and start up the relevant application (software) on the terminal device of the A subscriber:
(free) direct download onto the A subscriber terminal device
installation on the terminal device via PC link, e.g. via a USB port or the like
push technology via URL The subscription/application server is the network interface to the A subscriber terminal device and is used both for subscriber data management, (optional) monitoring of the A subscriber call control (call handling), for the management of network events and the signaling thereof to the A subscriber terminal device, and also as an interface to post-processing systems.

Usually, use of the application's scope of functions which is based on network events requires one-off logon by the A subscriber.

In this case, there may be various logon options for the A subscriber, for example via a text or multimedia message (SMS, MMS) or else via computer networks such as the Internet via appropriate Internet interfaces. The scope of those network events which can be used by the application of the terminal device for action control is likewise defined on the subscription/application server.

In exceptional cases, the network events required for controlling actions on the A subscriber terminal device, i.e. the application, are signaled to the relevant A subscriber terminal device independently by the network. In this case, it is possible to dispense with the logon to the subscription/application server for the purpose of event signaling and terminal device action control.

The invention is explained in more detail below with reference to the figures, in which:

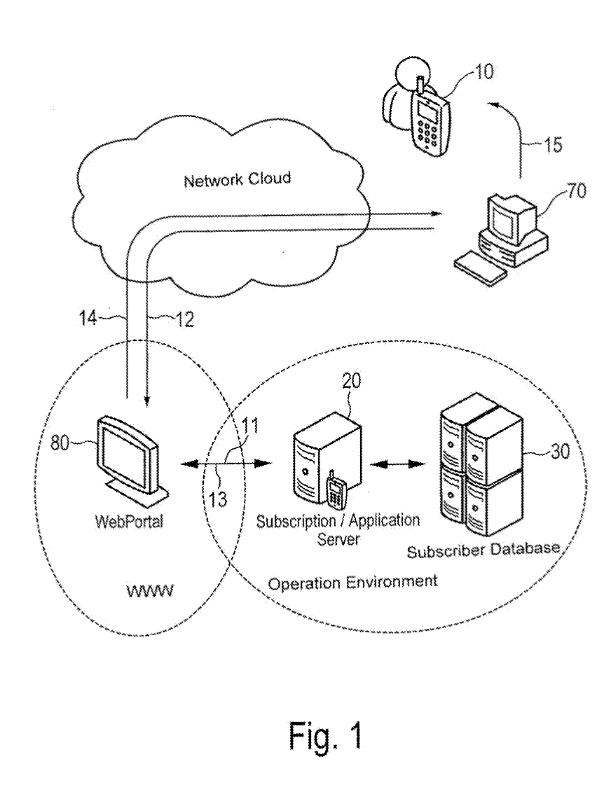

FIG. 1 shows obtainment and installation of the application by means of a computer via a computer network;

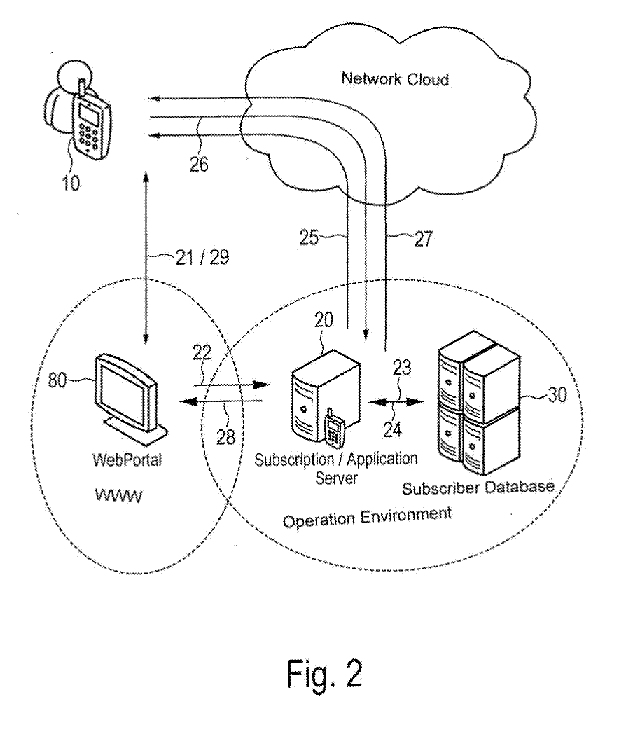

FIG. 2 shows logon and registration of the A subscriber (caller) via a network interface on the server via a computer network;

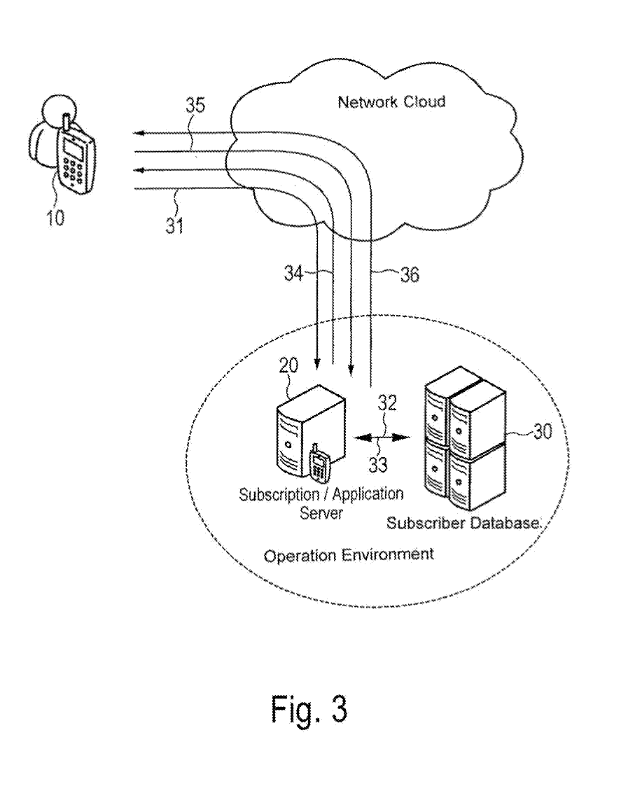

FIG. 3 shows logon and registration of the A subscriber (caller) on the server using binary communication;

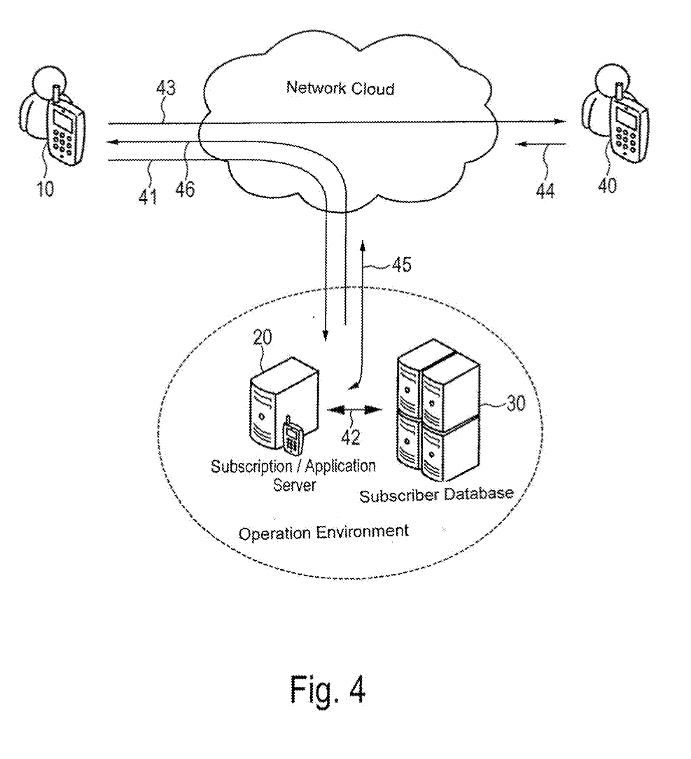

FIG. 4 shows an application example of the call control.

In the figures, identical components have been denoted by identical reference symbols.

FIG. 1 shows an example of the obtainment of the application for call control which is needed on the terminal device 10 of the A subscriber.

In the present example, the operator's own Internet portal 80 of the communication network operator is used by the customer/A subscriber to obtain the software.

The operator provides the application which is required for local use of the service for download via its own web portal 80 or via a third-party provider or the like to the server 20 by means of an appropriate request 11. This may be done either in the form of software packages which can executed directly on the terminal device 10 (handset) or in the form of source code information.

To this end, the customer/A subscriber uses his PC to connect to the web portal 80 by means of http/ftp/ssh or the like and, having indicated his MSISDN and selected 12 the terminal device/handset used (type/brand), downloads 14 his relevant application from the server 20.

The MSISDN and terminal device information is, in the present case, already stored 13 temporarily on the subscription/application server 20.

The application is installed 15 and configured by the A subscriber on the basis of the appliance-specific installation procedures on the terminal device 10 itself.

The configuration can take place before the actual activation of the service use on the terminal device 10 (on the basis of application and/or version).

FIG. 2 shows the logon via a network interface, wherein the application is downloaded via the air interface of the mobile radio terminal device 10. The customer/A subscriber wishes to install the required application on his own terminal device 10 using a PC or using the air interface and, in relation to obtainment and use, decides on the Internet interface logon variant.

The customer/A subscriber calls the web portal 80 (Internet page) of the relevant service operator and logs on for use by using the terminal device 10 to indicate 21 his MSISDN and the terminal device 10 used (type/brand).

The web portal 80 forwards 22 this logon information to the subscription/application server 20.

When the data provided by the A subscriber have finished being checked/authenticated 23 using post-processing systems or databases 30, an appropriate subscriber entry is created in the database 30 on the subscription/application server 20.

If necessary, the information from the installation is forwarded to post-processing systems for the purpose of customer provisioning, e.g. particular entries in the home location register, accounting option, or the like 24.

Optionally, in parallel therewith, it is also possible for the A-subscriber initiated request/logon to be checked/authenticated by existing subscriber databases 30. It would be possible to restrict this to existing customer groups.

On the basis of legal and technical requirements, in this example the logon check by the server is performed by means of a confirmation query 25 which is additionally sent by the subscription/application server and which needs to be answered in the positive by the A subscriber.

Since, in the case of logon via the Internet interface 80 (web interface), it cannot be assumed that the application is available on the terminal device 10 of the A subscriber that is used, this query 25 and confirmation 26 are provided using standard SMS (SMS=short message service, text message). Following transmission of the OK/not OK information 26 to the server 20, the A subscriber is sent a final SMS 27 of appropriate content. It is conceivable for the A subscriber also to be notified of a temporarily valid reference (link) to the subscription/application server 20 at the same time, via which the direct transmission of request software is made to the A subscriber via an air interface in line with the indicated terminal device 10 (type/brand).

Should the logon process started by the A subscriber on the web portal 80 still be active, the logon confirmation 28 is also transmitted 29 to the A subscriber in this way.

The logon is then implemented and the subscriber can use the service, at best without delay.

In the example shown in FIG. 3, the logon, i.e. the subscription, and registration are effected using binary messages in the form of binary SMSs.

The customer/A subscriber has installed and configured the application locally on his own terminal device 10 using his PC and now wishes to use the functionality provided by the communication network operator.

For this purpose, he decides upon the variant of service activation via the terminal device application, which necessitates communication between the terminal device 10 and the subscription/application server 20 on the basis of binary SMSs which cannot be viewed by the customer.

The customer uses the terminal device to select the “service activation” function, which initiates the dispatch of a binary SMS 31 (of appropriate content) to the subscription/application server 20.

On the subscription/application server 20, an entry which can be associated with the sender is created and, if necessary, the information from the installation is forwarded to post-processing systems/databases 30 for the purpose of customer provisioning (e.g. trigger allocation on the HLR (home location register), accounting option . . . ).

Optionally, in parallel therewith, it is also possible for the A-subscriber initiated request/logon 32 to be checked/authenticated by existing subscriber databases 30. It would likewise be possible to restrict this to existing customer groups.

On the basis of legal and technical requirements, in this example the logon check is performed by means of a confirmation query 33 which is sent by the subscription/application server.

Said confirmation request is received by the terminal device application likewise as a binary SMS, is indicated to the customer/A subscriber via the display of the terminal device 10, i.e. via a graphical user interface, for the purpose of confirmation, and the OK/not OK information 35 is transmitted to the server 20 again.

The logon is now implemented and the subscriber can use the service, at best without delay. As confirmation 36, the subscriber is sent a further SMS of appropriate content.

FIG. 4 shows an application example of the call control according to the invention.

After downloading a freely available application (e.g. JAVA/WinMobile), the customer/A subscriber sends an SMS 41 in order to log on to the subscription/application server 20 and then selects a profile of announcements for the case “subscriber busy”, and also the action “return call reminder if busy” on his terminal device 10.

In the background, besides the customer logon for a known functionality, the test 42 for customer data consistency takes place using transmitted identifiers such as MCC (Mobile Country Code—country identifier for the addressing of mobile radio stations) and/or MNC (Mobile Network Code—code for identifying mobile radio networks). This allows a restriction to certain customer groups by the service operator. The check is performed by means of a query 42 by the server 20 in a database 30 which is associated with the server 20 and has the relevant customer data.

If a call 43 to another terminal device 40 (i.e. to the B subscriber) is now initiated from the relevant terminal device 10 and the network sends a “Busy” acknowledgment 44, this event 44 is picked up 45 from the network by the subscription/application server 20 and is signaled 46 to' the application on the terminal device 10 for further evaluation.

On the A subscriber terminal device 10, those actions linked to the “busy” event are then performed . . . i.e. the previously implemented announcement is addressed/played back by said event and, in parallel therewith, an appointment is created in the A subscriber calendar with the subject line “return call to No xxx required”.

Different speakers or ready-made text are conceivable for the announcement profile.

Since the relevant application can also be provided as open source software, it is possible for the scope of functions of the application to be freely extended by the customer.

1. A method for call control when setting up a communication link from a first calling terminal device, particularly from a mobile radio terminal device that logged into or associated with a first communication network, via one or more communication networks to at least one called terminal device, wherein a server associated with the first communication network is used to report back the current status to the calling terminal device from the network, wherein an application is used to evaluate the status reported back from the network and that a plurality of different actions can be defined and performed within the call control upon the status reported back from the network, wherein depending on said status one or more action(s) is/are performed that emanate(s) from the first calling terminal device or that is/are allocated thereto.

2. The method according to claim 1, wherein the status reported back to the first terminal device from the network is the call status or login status of the called terminal device or the availability of the called terminal device or the network status, particularly the availability of the network or resource availability within the communication network(s).

3. The method according to in claim 1, wherein the actions that can be defined for call control are the transmission of an identifier of the calling terminal device or of a predeterminable individual announcement or recording or of a generated announcement or of a text message or of a multimedia message that is transmitted to the called terminal device or to a memory unit associated with said terminal device.

4. The method according to claim 1, wherein the actions that can be defined for call control is a call diversion or a call forwarding.

5. The method according to claim 1, wherein the action(s) to be performed depending on of the status report within the call control is/can be configured using a user interface associated with the first terminal device.

6. The method according to claim 1, wherein an application is provided that can be/is used to configure the action(s) to be performed depending on of the status report within the call control.

7. The method according to claim 1, wherein an application is provided that is used to control the action(s) to be performed depending on the status report, wherein said application is executed on the first calling terminal device or on a server associated with the first communication network or partly on the first calling terminal device and on a server associated with the first communication network.

8. The method according to claim 1, wherein an application is provided that is used to execute or control the method, wherein said application is executed on the first calling terminal device, and wherein the application is provided by a server associated with the first communication network and is transmitted to the terminal device.

9. The method according to claim 1, wherein a log on or a registration of the user of the first terminal device is performed at a server associated with the first communication network, particularly by means of a transmission of a telephone number associated with said first terminal device, particularly an ISDN or an MSISDN, or an appliance number, wherein a status report is transmitted by the network server only to logged-on or registered terminal devices.

10. The method according to claim 1, wherein the first calling terminal device is a mobile radio terminal device within a mobile radio network.

11. A computer program product that performs the method according to claim 1 when it is executed on a terminal device, particularly a mobile radio terminal device, or on a server associated with the communication network, particularly a mobile radio network, or when it is partly executed on a terminal device, in particular a mobile radio terminal device, and partly on a server associated with the communication network, particularly a mobile radio network.
